(19) United States
(12) Patent Application Publication
(10) Pub. No.: US 2025/0045849 A1
(43) Pub. Date: Feb. 6, 2025

(54) PROJECTED CLOSING DATE TOOL FOR LOAN TRANSACTIONS

(71) Applicant: Wells Fargo Bank, N.A., San Francisco, CA (US)

(72) Inventors: Kimberly Ann Catlin, Middletown, MD (US); Michael Bruce Colter, Oviedo, FL (US); Suchita Avinash Dabholkar, Fremont, CA (US); Aniruddha Ghosh, Charlotte, NC (US); Balaji Gopalakrishnan, San Francisco, CA (US); Abhishek Kumar, Jharkhand (IN); Manish Pandey, Bengaluru (IN); Sivamurugan Paramasamy, Waukee, IA (US); Alex O. Resh, Des Moines, IA (US)

(21) Appl. No.: 17/647,379

(22) Filed: Jan. 7, 2022

Related U.S. Application Data
(60) Provisional application No. 63/199,561, filed on Jan. 8, 2021.

(51) Int. Cl. G06Q 50/16; G06Q 40/02

(52) U.S. Cl. CPC G06Q 50/167; G06Q 40/03

(57) ABSTRACT

An example electronic computing device can be programmed to: receive a status and a date for each of a plurality of loan components associated with a loan transaction, the loan transaction being purchase or refinance of a loan for a property; use an operating service level associated with each of the plurality of loan components to calculate a projected completion date for each of the plurality of loan components; and project a closing date based upon a longest of the projected completion date. The electronic computing device can calculate the operating service levels using artificial intelligence.

### BACKGROUND

A loan for the purchase of a new property or refinance of an existing property has many components. These components can include appraisals, titling and insurance, and approvals from governing organizations. Further, the statuses of the components of the loan transaction must be orchestrated in a particular order to meet necessary milestones.

The closing date for the transaction can be important. For instance, the purchase of a first property may need to be completed before a seller can purchase a second property. This coordination can be impacted when the transactional milestones are delayed or otherwise rescheduled, which may result in the modification of the closing date.

### SUMMARY

Embodiments of the disclosure are directed to tools that use components of a loan transaction, origination milestones, and historical performance data to project a closing date for the loan transaction.

In one aspect, an example electronic computing device includes: a processor; and a system memory, the system memory including instructions which, when executed by the processor, cause the electronic computing device to: receive a status and a date for each of a plurality of loan components associated with a loan transaction, the loan transaction being purchase or refinance of a loan for a property; use an operating service level associated with each of the plurality of loan components to calculate a projected completion date for each of the plurality of loan components; and project a closing date based upon a longest of the projected completion date.

The details of one or more techniques are set forth in the accompanying drawings and the description below. Other features, objects, and advantages of these techniques will be apparent from the description, drawings, and claims.

### DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 shows an example environment that supports calculation of a projected closing date for a loan transaction.

FIG. 2 shows example logical components of the projected closing date tool of the environment of FIG. 1.

FIG. 3 shows an example interface of the projected closing date tool of FIG. 2.

FIG. 4 shows an example table of operating service levels used by the interface of the projected closing date tool of FIG. 3.

FIG. 5 shows another example interface of the projected closing date tool of FIG. 3.

FIG. 6 shows another example interface of the projected closing date tool of FIG. 3

FIG. 7 shows additional example logical components of the projected closing date tool of the environment of FIG. 1.

FIG. 8 shows additional example logical components of the environment of FIG. 1.

FIG. 9 shows an example method for prioritization performed by the components of the environment of FIG. 8

FIG. 10 shows example logical components of a user computing device of the environment of FIG. 1.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

The examples provided herein are directed to projected closing date tools that use components of a loan transaction, including milestones and historical performance data, to project a closing date for the loan transaction. The projected closing date, in turn, can be used to determine if the loan transaction will close within a desired timeframe.

Generally, the projected closing date tools accept input from the user. This input can include transactional components, current statuses, and status dates associated with the loan transaction, such as a mortgage or refinance for a property. Based on the operating service levels associated with the components of the loan transaction, the projected closing date tools apply logical functions to project a closing date for the loan transaction.

In some scenarios, the projected closing date tool is used by a loan facilitator who is assisting a borrower through the mortgage or refinance process. The loan facilitator can use the projected closing date tool to track and set expectations for the borrower relating to the closing date for the loan transaction.

For instance, a projected closing date tool is used to assist a loan facilitator when working with a borrower on the purchase or refinance of a property. Upon receipt of the various components associated with the loan transaction, the projected closing date tool uses operating service levels to project the closing date for the loan transaction. This projected closing date compares the projected closing date to the expiration of the interest rate lock and the borrower's expected close date for the loan transaction to determine a favorable or unfavorable response. This information is provided to the loan facilitator to assist the loan facilitator in counseling the borrower during the loan transaction.

In this example, the projected closing date tool can be used at loan approval and thereafter to project the closing date and update the projected closing date as the transactional components, current statuses, and status date change during the loan process. The projected closing date tool can further be used to identify potential delays so that mitigation activities can be performed and monitor the pace of the transaction to meet expectations associated with the closing date of the loan transaction.

If the projected closing date from the projected closing date tool is unfavorable (e.g., falls after the expiration of the rate lock and/or does not meet one or more of the borrower's expectations), the projected closing date tool can provide an alert to the loan facilitator, or the borrower (or both). The loan facilitator can discuss the noted issue(s) with the borrower and make necessary adjustments, such as modification of one or more of the components within the projected closing date tool.

In other optional examples, the user of the projected closing date tool is the borrower in the loan transaction. The borrower can use the tool throughout the loan transaction to provide a projected close date.

The tools described herein provide a solution to a technical problem, specifically how to take data from disparate sources and provide an accurate projection for a closing date for a loan transaction. For instance, the tool can use historical data from disparate sources to calculate operating service levels to provide the practical application of estimating a time needed to perform different loan components associated with the loan transaction. Further, the tool can receive inputs from various sources associated with the loan transaction, process those inputs along with the operating service levels, and provide a real-world outcome of a projected closing date and alerts associated with any issues associated with that projected closing date. Finally, the tool includes an interface that is optimized, in that the interface receives and presents data in an efficient manner.

In addition, there are various advantages that can be associated with the use of artificial intelligence to provide a projected closing date. For instance, the use of artificial intelligence can, in some instances, allow for an increased amount of data that is used to calculate various operating service levels, thereby enhancing the accuracy of the projected closing date. Further, the use of artificial intelligence can, in some instances, allow for the projected closing date to be updated more frequently as further information is received. This can be accomplished, for example, through a sequence of models that is used to calculate one or more of the operating service levels associated with the projected closing date.

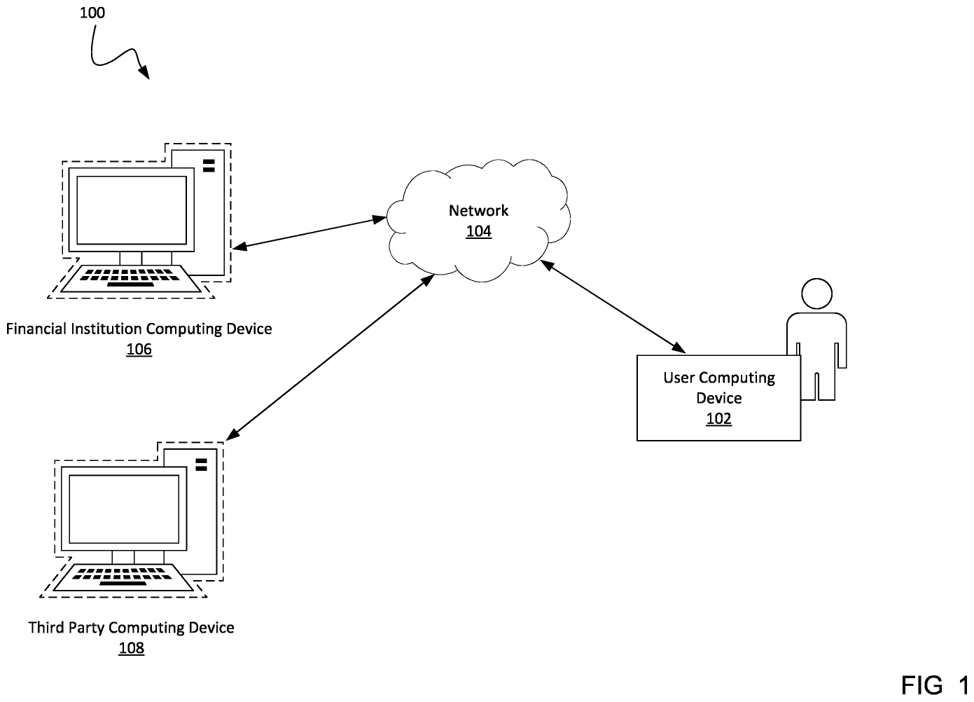

FIG. 1 illustrates an example environment 100 that facilitates the projection of a closing date for a loan transaction associated with the purchase or refinance of a property. The environment 100 includes a user computing device 102, a network 104, a financial institution computing device 106, and a third party computing device 108. More or fewer computing devices can be provided in the example environment 100.

In this example, the user computing device 102 is associated with the loan facilitator of a financial institution that facilitates the loan transaction. The financial institution computing device 106 is associated with the financial institution, such as a bank. As described more below, the user computing device 102 can communicate through the network 104 with the financial institution computing device 106. Although the financial institution computing device 106 is depicted as a single device, in a typical environment the financial institution computing device 106 could be one server in a server farm and/or cloud computing environment.

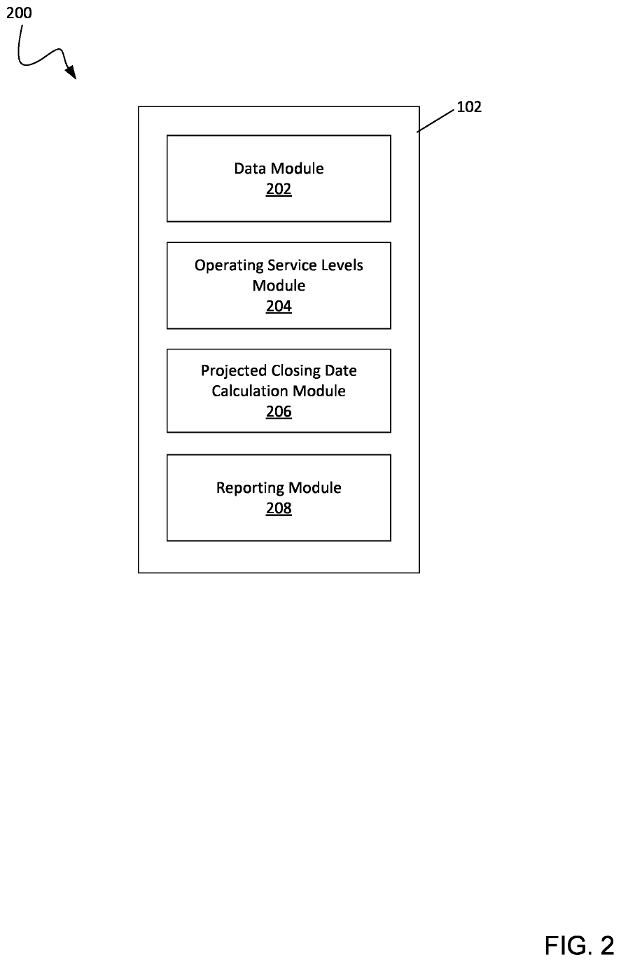

In this example, the user computing device 102 communicates with the financial institution computing device 106 in order to obtain a projected closing date. This is accomplished by a projected closing date tool 200 (see, for example, FIG. 2) that executes on the user computing device 102 or the financial institution computing device 106. The projected closing date can be communicated by the loan facilitator to the borrower and/or other interested parties associated with the loan transaction.

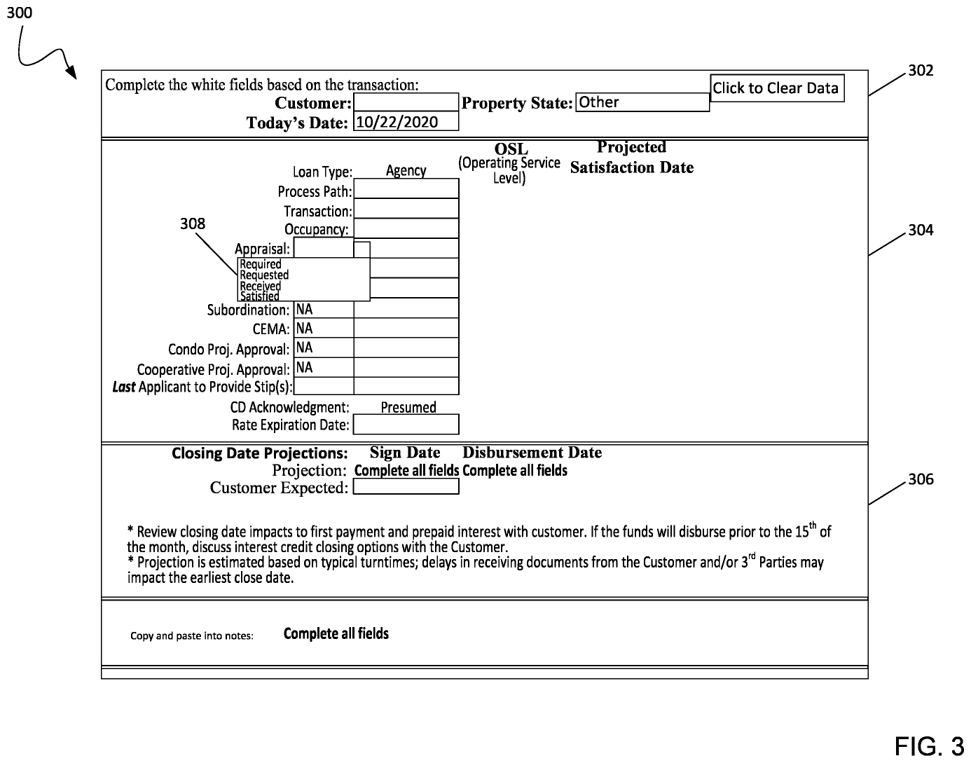

The third party computing device 108 communicates with the financial institution computing device 106 to provide data that can be used by the projected closing date tool 200 to project the closing date. As described further below, this can include data relating to operating service levels that allow the projected closing date tool 200 to project the closing date. See, for example, FIG. 3.

The example network 104 is a computer network and can be any type of wireless network, wired network, and cellular network, including the Internet. As noted, the user computing device 102, the financial institution computing device 106, and the third party computing device 108 can communicate with each other via the network 104.

FIG. 2 illustrates example logical components of the projected closing date tool 200. In the examples provided below, the projected closing date tool 200 is loaded from memory and executed by a central processing unit on the user computing device 102. However, in other examples, portions or all of the projected closing date tool 200 can be executed on the financial institution computing device 106. Many configurations are possible.

In this example, the projected closing date tool 200 generally receives input and generates a projected closing date for a loan transaction. The projected closing date tool 200 includes a data module 202, an operating service levels module 204, a projected closing date calculation module 206, and a reporting module 208.

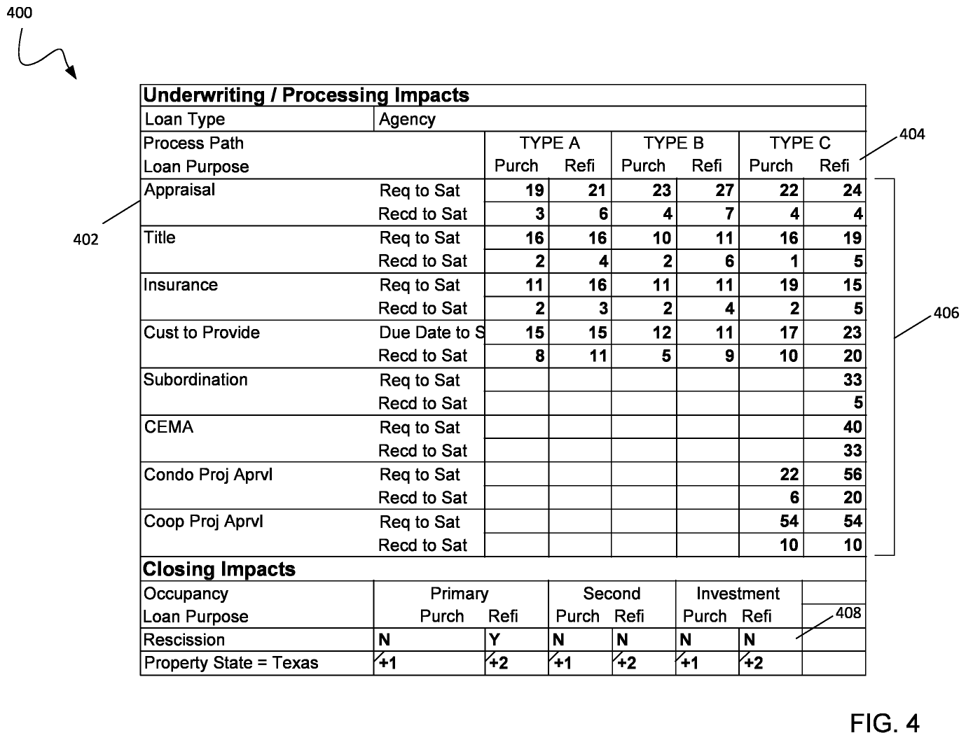

The example data module 202 receives input from various data sources to project the closing date. These sources can be both internal to the financial institution as well as external to the financial institution. For example, the data module 202 can receive input from the user, such as the loan type and statuses of the components for the loan transaction. Sec, e.g., FIG. 3. Further, the data module 202 can receive input from data sources internal to the financial institution computing device 106, such as data associated with operating service levels (see FIG. 4) and data associated with reporting requirements. In optional embodiments, the data module 202 can also receive data from the third party computing device 108, such as data associated with operating service levels. See, for example, FIG. 4.

The example operating service levels module 204 receives the data from the data module 202 and defines operating service levels associated with the loan transaction. See, for example, FIG. 4. In this example, the operating service levels are calculated at periodic intervals (e.g., quarterly) by the financial institution computing device 106 and accessed by the operating service levels module 204. In other optional examples, the operating service levels module 204 receives the data from the data module 202 and calculates the operating service levels in near real time. For instance, the operating service levels module 204 may receive the data from the data module and calculate the operating service levels on-demand in response to a request for a projected closing date (and the data associated therewith for reporting). Since data often changes, such an example provides a benefit of increased accuracy in projected closing date. Other configurations are possible.

The example projected closing date calculation module 206 receives data from the data module 202 and the operating service levels from the operating service levels module 204. This data is then used to project a closing date for the loan transaction. See, for example, FIG. 3. As further discussed herein, the projected closing date can be calculated dynamically and on-demand.

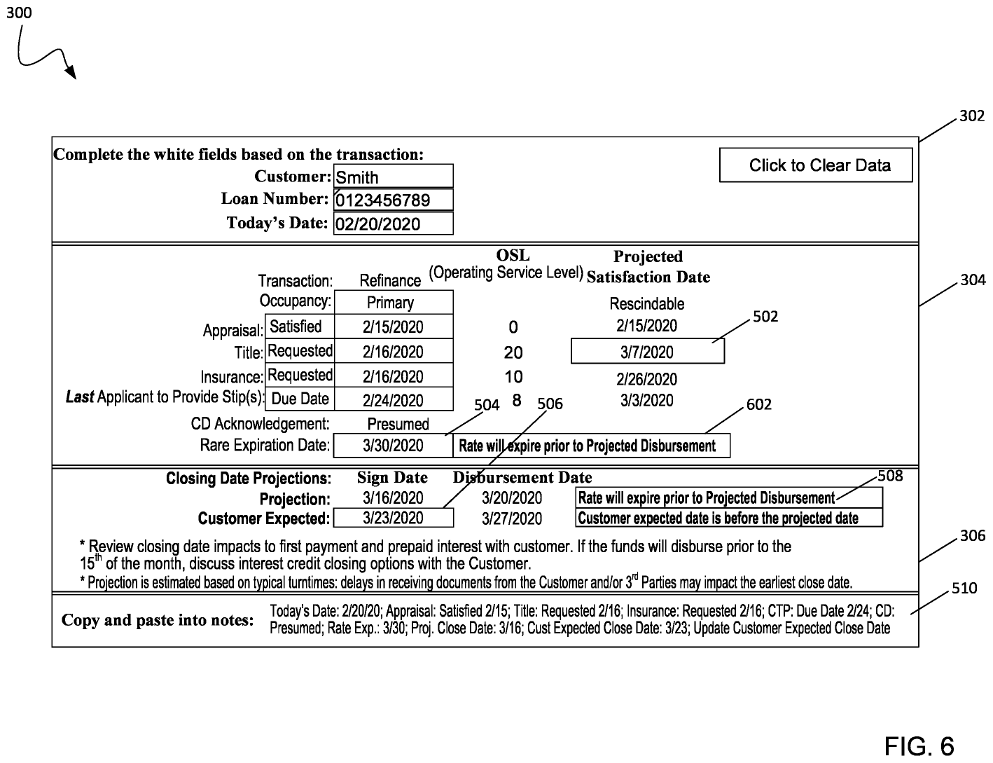

The example reporting module 208 assembles the projected closing date and the data associated therewith for reporting. This can include providing the projected closing date to the user of the user computing device 102. Also included is providing any alerts associated with the projected closing date. See, for example, FIG. 6. Finally, the reporting module 208 can summarize the data and projected closing date for storage in a repository.

Referring now to FIG. 3, an example interface 300 of the projected closing date tool 200 is shown. In this example, the interface 300 is a spreadsheet file (e.g., XLSX-Microsoft Excel Open XML spreadsheet format) created by the Excel spreadsheet program from Microsoft Corporation. The spreadsheet can be provided with added functionality, such as by one or more macros written in Visual Basic for Applications (VBA) within the Excel spreadsheet program. Other configurations are possible. For instance, the interface 300 could be a web-based interface generated and displayed by a web application executed by a computing device, or a mobile application interface generated and displayed by a mobile device.

Generally, the interface 300 for the projected closing date tool 200 accepts input from the user and projects a closing date for a loan transaction. This input can include statuses and dates for outstanding components associated with the loan transaction.

For example, the interface 300 is configured to receive the current statuses and dates for loan components from the loan facilitator at various milestones of the loan transaction (e.g., during the initial conversation with the borrower after the loan transaction has been approved). The projected closing date tool 200 applies various operating service levels associated with the loan components statuses and dates to project a closing date. The projected closing date tool 200 displays a favorable message if the projected closing date aligns with the logic, or a warning message for any specific loan components that may need to be addressed.

More specifically, the interface 300 includes an example bibliographic section 302 that receives information like the borrower's name (“Customer”), the date, and the state in which the property is located (“Property State”). The bibliographic section 302 may include one corresponding boxes (e.g., a customer box, a property state box, a date box, etc.) for displaying the corresponding information. While shown as boxes, in various other examples other display fields may be used, such as cards, windows, lists, menus, bubbles, icons, etc. In certain examples, fields may be editable, or editable by only those with authorization (e.g., only editable by the loan facilitator).

The interface 300 also includes an example status section 304 that receives information about the status of various components of the loan transaction. For instance, the components can include the following:
Process Path—each process path has different calculated operating service levels which impact the output;
Transaction—defines whether the loan transaction is a purchase or refinance (needed to determine right of rescission requirements);
Occupancy—defines whether the property will be a primary residency, a secondary residency, or an investment (needed to determine right of rescission requirements);
Appraisal—status of the appraisal for the property;
Title—status of title insurance for the property;
Insurance—status of homeowners insurance for the property;
Subordination—status of any subordination liens associated with the property (not be applicable for all loan transactions);
CEMA (Consolidation, Extension and Modification Agreement)—status of the Consolidation, Extension and Modification Agreement associated with the loan transaction (may not be applicable for all loan transactions);
Condo Proj Approval—status of any approval(s) needed from a condominium association for the property (may not be applicable for all loan transactions);
Cooperative Proj Approval—status of any approval(s) needed from a cooperative association for the property (may not be applicable for all loan transactions);
Last Applicant to Provide Stip(s)—date for the last applicant to provide stipulations for the loan transaction;
CD (Closing Disclosure) Acknowledgement—status of the acknowledgement of the Closing Disclosure (presumed to be three business days in some instances; can be waived in some instances); and
Rate Expiration Date—the date at which the interest rate for the loan transaction expires.

The status section 304 further includes a status (required, requested, received, satisfied and the actual date the status occurred) for each of the components that are required for the loan transaction:
Required—component is necessary, but order has not been placed;
Requested—order has been placed with a vendor;
Received—documentation has been received from the vendor;
Satisfied—stipulation has been satisfied; and
Due Date—agreed upon due date for borrow to provide requested documents.

The status section 304 provides an operating service level (see, e.g., FIG. 4) and a projected satisfaction date for each of the components, which are again detailed further below.

When a loan component is not required for a particular transaction, the status for that loan component can be indicated as not applicable (N/A). For instance, if the loan transaction is not associated with the sale of a condominium, the Condo Proj Approval loan component would not be applicable.

Similar to the bibliographic section 302, the status section 304 may include one corresponding boxes (e.g., a process path box, a transaction box, etc.) for displaying the corresponding information. While shown as boxes, in various other examples other display fields may be used, such as cards, windows, lists, menus, bubbles, icons, etc. In certain examples, fields may be editable, or editable by only those with authorization (e.g., only editable by the loan facilitator).

Finally, the interface 300 includes an example projected closing date section 306 that provides information about the projected closing date for the loan transaction. This includes the projection for the closing date (“Projection”), the date by which the borrower expects the closing to occur (“Customer Expected”), and ancillary information associated with the projection, including general information, any recommended action, and a summary of the projection that can be used for reporting.

Data entry fields for the interface 300 are controlled through drop downs and/or formatting. For instance, a drop down menu 308 is provided for the selection of the status for each of the loan components.

All of the necessary fields on the interface 300 are required to be completed in order for the projected closing date tool 200 to generate a projected closing date. For example, the projected closing date tool 200 can require that certain data be provided before a projected closing date is calculated. Prior to receiving the necessary data, the projected closing date tool 200 can indicate that a projected closing date cannot be calculated (e.g., by providing a notification like “Complete all fields” in the projected closing date field(s)).

In one example, the projected closing date tool 200 requires the following information before a closing date is projected: today's date; process path; transaction type, occupancy type, date for each required loan component; rate expiration date, and customer expected date. Further, the projected closing date tool 200 requires that the status for each required loan component not be “Required” because an operating service level cannot be calculated until the loan component is at least at the “Requested” status.

In certain examples, formatting rules minimize erroneous data entry on the interface 300. These formatting rules include checks on the data that is received by the projected closing date tool 200. For instance, if the projected closing date tool 200 receives non-date data in one of the date fields associated with a loan component, the projected closing date tool 200 can optionally provide an error message on the interface 300 to highlight the potential issue. Other configurations are possible.

Logic fields are hidden and locked from the user of the projected closing date tool 200. For instance, the table associated with the operating service levels (see, e.g., FIG. 4) is hidden from the end user.

Referring now to FIG. 4, an example table 400 shows additional details about the operating service levels. As previously noted, the table 400 is hidden from the user of the projected closing date tool 200 on the user computing device 102. The table 400 is used by the projected closing date tool 200 to determine the operating service levels for each relevant component of the loan transaction.

In the illustrated example, the data used to define the operating service levels in the table 400 is obtained from within the financial institution by the financial institution computing device 106. In other examples, at least some of the data used to define the operating service levels is also obtained by the financial institution computing device 106 from third parties, such as the third party computing device 108. For instance, data associated with the time necessary to complete an appraisal for a property can be estimated based upon both (i) historical information from other loan transactions within the financial institution and (ii) operating information directly from one or more third party vendors that actually perform the appraisals.

In the example shown, the operating service levels in the table 400 by using both historical internal and external data from a previous time period, in this instance the previous 90 days. Using the average, median, and frequencies, conservative static operating service levels for each relevant are derived for both purchase and refinance loan transactions for each relevant loan component.

In some examples, additional strategic information is used in combination with the historical performance to set the operating service levels. For instance, market intelligence and oversight can be used to frame current performance with future projections to determine the optimal operating service levels. Other configurations are possible.

In this example, the table 400 provides the operating service levels for each component from the requested to satisfied, and received to satisfied intervals. In other words, each status (Requested, Received and Due Date) gets a calculated turn time and is added together to determine the expected operating service level that is then used by the projected closing date tool 200 to project a closing date for the current loan transaction.

The table 400 is broken into sections. A section 402 lists the relevant loan components (e.g., appraisal, title insurance, etc.). A section 404 provides columns with the different process paths for different Types A-C of loan transactions (e.g., one type of loan transaction may follow a digital-only path with all interactions handled digitally, while another type of loan transaction may follow a standard, paper-based path). A section 406 provides the relevant operating service levels for each loan component for each process type, broken down by purchase (Purch) and refinance (Refi). Finally, a section 408 lists other impacts to the transaction process, such as rescission and location of the property (e.g., Texas requires additional review time for borrowers).

In some examples, the projected closing date is further adjusted based upon common contingencies associated with these types of loan transactions. For example, the projected closing date tool 200 adds 10 days to the projected closing date for closer activities and presumed receipt of the Borrower Closing Disclosure. As previously noted, the operating service levels are calculated and updated by the financial institution computing device 106 on a periodic basis, such as quarterly, using a conservative value based on the mean/median for the last 3 months (90 days). Mean and median values are reviewed to determine the operating service levels. In some cases, the median is leveraged as the mean may have statistical outliers skewing the satisfaction turn time. Many other configurations are possible.

For example, in alternative embodiments, the operating service levels are automatically calculated in near real time and provided to the projected closing date tool 200 upon calculation of a projected closing date. For instance, the financial institution computing device 106 can receive both internal data and external data (e.g., from the third party computing device 108 associated with one or more vendors) on a periodic or near real-time basis and continually update the operating service levels. The projected closing date tool 200 can be programmed to receive the updated operating service levels each time the projected closing date tool 200 calculates a projected closing date, thereby increasing the potential accuracy of the projected closing date tool 200. Other configurations are possible.

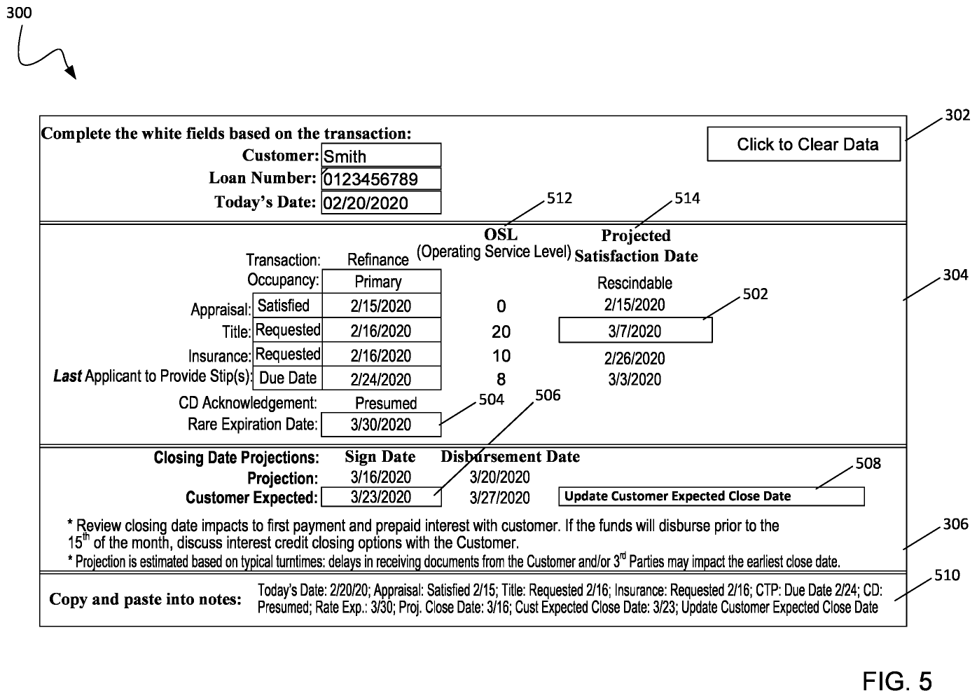

Referring now to FIG. 5, the interface 300 is shown with data used by the projected closing date tool 200 to project a closing date.

In this non-limiting example, the interface 300 of the projected closing date tool 200 has received data from the loan facilitator (or borrower) associated with all of the necessary loan components for the example loan transaction.

The interface 300 includes an operating service level column 512 that provides the relevant operating service level (from the table 400) for each of the loan components listed in the status section 304. The interface 300 also includes a projected satisfaction date column 514 that is the date projected by the projected closing date tool 200 for the satisfaction of each of the loan components.

Note that the operating service levels in the operating service level column 512 and the corresponding projected satisfaction date in the projected satisfaction date column 514 are modified by the projected closing date tool 200 as each loan component changes. Further, once a loan component is satisfied (e.g., completed), the operating service level in the operating service level column 512 is listed as zero (0), and the projected satisfaction date column 514 is identical to the satisfaction date.

In the status section 304, the interface 300 highlights (e.g., in a bright color, such as yellow) a last loan component 502 having the last expected satisfaction date based upon the operating service levels used by the projected closing date tool 200. For instance, the last loan component 502 in this example is the title, which was requested on Feb. 16, 2020 and has an operating service level of 20 days from request until satisfaction estimated at Mar. 7, 2020. This allows the interface 300 to highlight any potential problems with the deadlines associated with the loan components of the loan transaction.

The interface 300 further includes an alert 508 in the projected closing date section 306. In this example, the alert 508 is favorable because the projected closing date of Mar. 16, 2020 is after: (i) the date (Mar. 7, 2020) of the last loan component 502; the date (Mar. 30, 2020) of a rate expiration field 504; and a date (Mar. 23, 2020) of a customer expectation field 506. The alert 508 is therefore highlighted in a positive color (e.g., green) to signify to the loan facilitator that the loan transaction is likely to proceed without an issue.

In this example, the projected closing date section 306 projects two dates: a projected sign date for the loan transaction, which is when the documents associated with the loan transaction will be signed by the borrower; and a projected disbursement date for the loan transaction, which is when the funds will actually be sent to the borrower. Other configurations are possible.

The projected closing date section 306 also includes a summary section 510 that dynamically summarizes the data received by the projected closing date tool 200. This includes the dates associated with the loan components, the projected closing date, and any alerts. The summary section 510 can be accessed (e.g., copied) and stored in a loan record associated with the loan transaction. In one example, the storage is manually, allowing the loan facilitator to copy the text created by the projected closing date tool 200 into the record. In an alternative embodiment, the text is automatically sent by the projected closing date tool 200 to the financial institution computing device 106 for storage. Dynamically generated summaries offer the improvement of concise and consistently formatted synopses of the data of the projected closing date tool. Such a summary provides a quick, concise, and standardized snapshot, as of the date of the projection, of the status of the loan components. As described with reference to at least FIG. 5, the summary may be text-based summary that can manually or automatically be copied or exported to another software application. Other configurations are possible.

One non-limiting example of how the dates on the interface 300 are calculated by the projected closing date tool 200 is as follows. For the appraisal loan component, the interface receives a selection by the loan facilitator of the status of the appraisal (Requested, Received, Satisfied) from the drop-down list corresponding to that loan component. The interface 300 also receives the date that the status occurred.

The projected closing date tool 200 accesses the relevant operating service level corresponding to a status of Requested to Satisfied, which is then added to the entered date to determine the Projected Satisfaction Date. For instance, in one example, the appraisal was requested on Nov. 5, 2020, based on an operating service level of 28 days from request until the stipulation is satisfied the Projected Satisfaction Date is determined to be Dec. 3, 2020 (Nov. 5, 2020 plus 28 days). An excerpt of the interface that is consistent with this example is provided below.

| | | | | |
|---|---|---|---|---|
| Appraisal: | Requested | Nov. 5, 2020 | 28 | Dec. 3, 2020 |

This process is followed by the projected closing date tool 200 for all of the loan components (e.g., all of the loan component necessary fields). Once all inputs are received, in at least one example, the last loan component 502 in the Projected Satisfaction Date column is calculated by the projected closing date tool 200 according to the equation below.

$$Projected Satisfaction Date = max \{ ( Appraisal Status Date + {OSL}_{Appraisal \_ Status} ) , ( Title Insurance Status Date + {OSL}_{Title \_ Insurance \_ Status} ) , ( Homeowners Insurance Status Date + {OSL}_{Homeowners \_ Insurance \_ Status} ) , ( Subordination Agreement Status Date + {OSL}_{Subordination \_ Agreement \_ Status} ) if applicable , ( CEMA Status Date + {OSL}_{CEMA \_ Status} ) if applicable , ( Condo Project Approval Status Date + {OSL}_{Condo \_ Project \_ Approval \_ Status} ) if applicable , ( Cooperative Project Approval Status Date + {OSL}_{Cooperative \_ Project \_ Approval \_ Status} ) if applicable , ( Last Applicant to Provide Stipulation ( s ) Status Date + {OSL}_{Last \_ Applicant \_ to \_ Provide \_ Stipulation ( s ) \_ Status} ) \}$$

The projected closing date then is determined by the projected closing date tool 200 by adding additional days (e.g., 10 days) to the Projected Satisfaction Date. For example, using Dec. 3, 2020 as the longest date (per the above example), the projected closing date is determined by the projected closing date tool 200 to be Dec. 14, 2020.

$$Projected Close Date = ( Projected Satisfaction Date + 10 days )$$

Referring now to FIG. 6, another example use of the projected closing date tool 200 is provided. The interface 300 differs in that the projected closing date tool 200 projects a closing date (Mar. 16, 2020) for the rate expiration field 504 that is after the date (Mar. 19, 2020) in the rate expiration. In this instance, an alert 602 is provided by the projected closing date tool 200 noting that the interest rate lock will expire before the projected closing date. Further, the projected closing date is after a customer expected date (Mar. 9, 2020) in the customer expectation field 506. The alert 508 provides a summary of all potential issues, including the expiration of the rate and the customer expected date. That is, in addition to providing a synopses of the data of the projected closing date, the summary includes a summary of the potential issues (e.g., the issues corresponding to the alert 508). Such an example of the summary provides the benefit of a short and concise explanation of the potential issues, that is, more than just an identification of a potential issue.

In the examples provided above, the interface 300 of the projected closing date tool 200 receives input from the user (e.g., loan facilitator or borrow) for the dates and statuses associated with the loan transaction. In alternative embodiments, some or all of the data in the interface 300 is automatically populated from internal data or external data provided by the financial institution computing device 106. For instance, the projected closing date tool 200 can access the date and status associated with the appraisal for the loan transaction directly from the financial institution computing device 106 and automatically populate that data in the interface 300. Other configurations are possible.

Although the example projected closing date tools provided herein are described as being implemented in spreadsheet files for use with the Excel spreadsheet program, other programs and interfaces can be used. For instance, in another embodiment, a web-based interface (e.g., webpage built with Hypertext Markup Language (HTML) or other technology) can be provided. The interface can be displayed within a web browser, receive input relating to the loan transaction, access relevant operating service level data, and provide a projected closing date. In another embodiment, the projected closing date tools can be provided as widget(s) on a webpage that receives data input and projects a closing date. Other configurations are available.

For example, in alternative embodiments, the projected closing date tools can be implemented in one or more software applications that provide the functionality described herein.

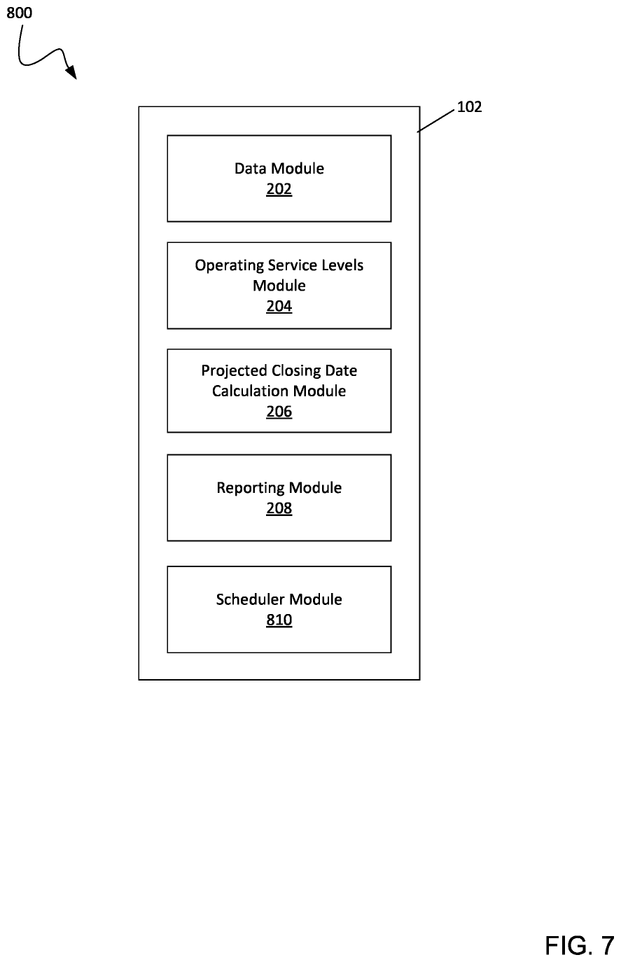

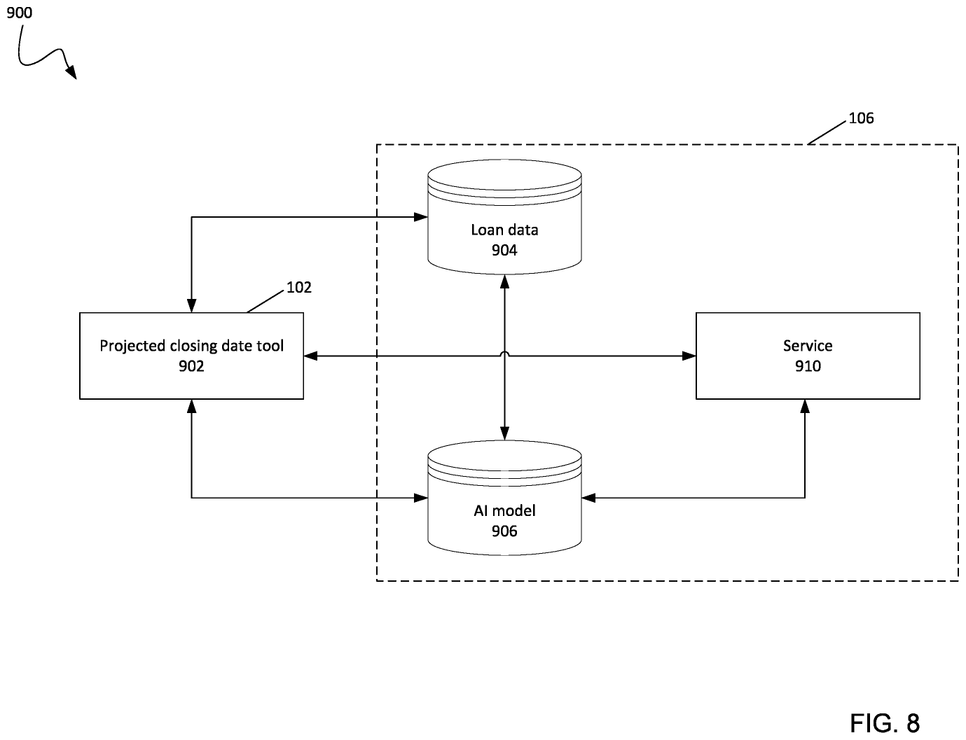

Referring now to FIGS. 7-8, another embodiment of a projected closing date tool 800 is shown. In this example, the projected closing date tool 800 is implemented as a standalone software application running on the financial institution computing device 106 described at least with reference to FIG. 1, although other configurations are possible. For instance, the projected closing date tool 800 can be incorporated directly into the operating system of the financial institution computing device 106 in alternative embodiments.

In this example, the operating service levels are automatically calculated on a periodic basis, such as weekly or monthly, based upon updated loan data. To accomplish this automatically, the projected closing date tool 800 includes a scheduler module 810 (illustrated in FIG. 7) that is programmed to cause the data module 202 to periodically access the data necessary to calculate the updated operating service levels.

Upon receiving periodic messaging from the scheduler module 810, the data module 202 is programmed to automatically access data. As previously noted, such data can include data sources internal to the financial institution computing device 106 and/or external from the third party computing device 108. The operating service levels module 204 can use the data obtained by the data module 202 to update the operating service levels used by the projected closing date tool 800.

In addition, the projected closing date tool 800 is programmed to provide operating service levels with greater granularity, in that the operating service levels can be calculated on the stipulation level, rather than the stipulation type.

For example, one stipulation type is the title associated with a loan. The projected closing date tool 800 is programmed not only to track a status of the stipulation type (title) as a whole, but to track each stipulation associated with title. In one example, this can include many stipulations (e.g., 5, 10, 20, 30, 50+) for each stipulation type. In the title example, such stipulations can include, without limitation: Title Insurance-Full Coverage; Property Tax Statement; Homestead Exemption; Texas Title; Title-Judgment Confirmation; Title-Liens Discrepancy; Current Owner of Record Does Not Match Customer-Preferred Vesting; Iowa Title Guaranty-Full Coverage; and Purchase Agreement with Addendums and Attachments.

These are just example stipulations. Additional or different stipulations can be provided for the title example, and many other stipulations can be provided for other stipulation types.

Referring now to FIG. 8, another example environment 900 that facilitates the projection of a closing date for a loan transaction associated with the purchase or refinance of a property is shown. In this example, a projected closing date tool 902 uses artificial intelligence to further enhance the closing predictions provided by the projected closing date tool 902.

More specifically, an artificial intelligence (AI) model 906 is built to replicate the assessment of loan performance, and determine the appropriate length of time in which a loan should close. The AI model 906 assesses the entire transaction profile for a loan (in some examples, approximately 600 elements) to identify those features that will have the greatest impact on loan performance, and the AI model 906 provides a suggested close date for the user.

The AI model 906 continuously learns from actual loan data provided by a loan data repository 904 and adjusts to changes in process capability and market changes. This continuous process of learning means that operating service levels are continually updated based upon new learning by the AI model 906, rather than being periodically updated.

In one example, the AI model 906 is generated using DataRobot from DataRobot, Inc. The AI model 906 can, in some examples, be broken into two models, with one model for purchase loan originations and another model for refinance loan originations.

Within each model, a sequence of sub-models can be created to address each loan component of one or both of the models. The sequence of sub-models can include a sub-model for each milestone of the loan processing workflow that predicts the loan processing time from each of these milestones.

For instance, different sub-models can be used for one or more of the milestones associated with each of the loan components. Various models can be tested, and the best model for each component milestone is selected. In examples, such models include, without limitation: (i) gradient boosting frequency-severity model (e.g., used for the milestone associated with refinance application to registration); (ii) light gradient boosted trees regressor with early stopping model (refinance registration to submission); (iii) light gradient boosting on elasticnet predictions model (refinance submitted to credit received); (iv) random forest regressor model (refinance clear to close to initial closing disclosure); and (v) ridge regression model (initial closing disclosure to closing documents). Many other model types and configurations are possible.

In this example, the AI model 906 ingests the loan performance information from the loan data repository 904 during training and continues ingesting data during operation. The AI model 906 learns as it ingests this loan performance information, and the learning continues as the AI model 906 receives more information. Training can be an iterative process: (i) loan performance information is pre-processed to transform, normalize, clean and encode the data; (ii) features within the data are classified, with sample selection being performed; (iii) model is trained using a machine learning algorithm selection process; and (iv) model is evaluated through experimentation, along with testing and tuning.

The projected closing date tool 902 communicates with one or both of the loan data repository 904 and the AI model 906 when being used to make predictions on closing dates. In one configuration, a service 910 is created that enhances the availability of the information provided by the AI model 906. The service 910 provides an application programming interface that allows the projected closing date tool 902 to access up-to-date operating service levels and closing date predictions for loans. For instance, the projected closing date tool 902 can be implemented as a software application that communicates with the service 910 as needed to provide more accurate predictions.

In some examples, the projected closing date tool 902 communicates with the service 910 and the AI model 906 according to a logical architecture that includes a contextual design that defines a context (e.g., document context, customer context, or loan context) for each data point. This architecture can include a common decisioning solution with one or more of: (i) pre-decisioning, which creates a dynamic application that leverages existing knowledge to more efficiency provide the loan processing to a customer; and (ii) a context engine that defines contextual relationships between items in the model, thereby allowing changes to be made and reflected appropriately throughout the entire model.

Examples of such a logical architecture are described in U.S. patent application Ser. No. 16/940,728 filed on Jul. 28, 2020, U.S. patent application Ser. No. 17/204,442 filed on Mar. 17, 2021, and U.S. patent application Ser. No. 17/204,583 filed on Mar. 17, 2021, the entireties of which are hereby incorporated by reference.

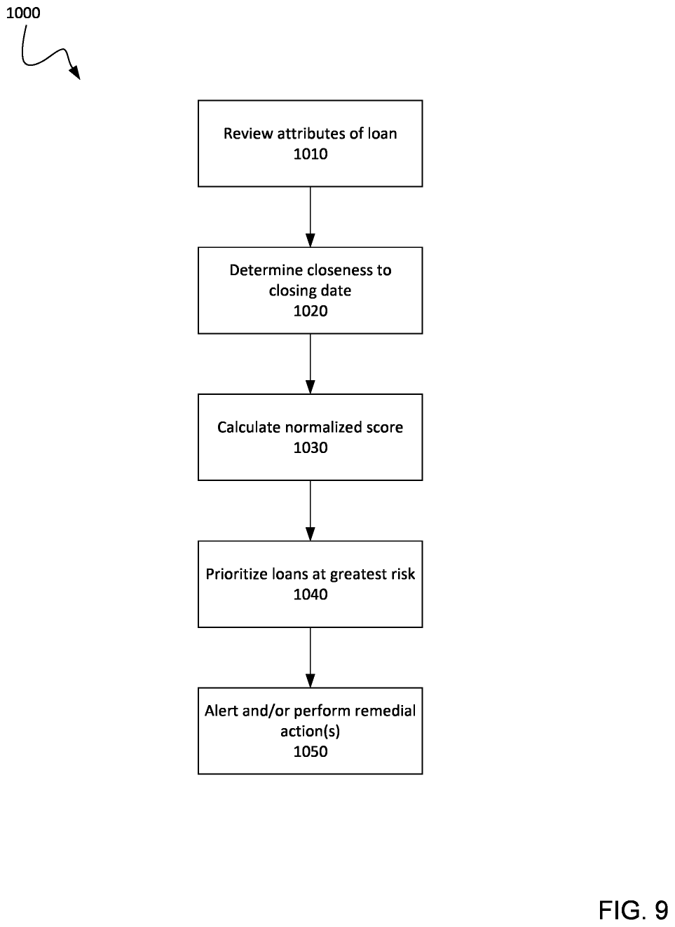

Referring now to FIG. 9, an example method 1000 for prioritization of various loans handled by the financial institution is provided.

Generally, the prioritization can include a monotonic score with highly-scored loans at a higher risk of missing scheduled closing dates. This can help in prioritizing the loan handling at each milestone. The scoring can also help minimize the overall waiting times across all milestones.

The prioritization can be determined by assessing a status of each loan relative to a projected closing date and identifying those loans that are at greater risk of not meeting those dates.

At step 1010 of the method 1000, various attributes for each loan are reviewed. These attributes can vary depending on how risk is attributed within the environment. One example of such an attribute is loan type. One particular type of loan (e.g., original versus refinance) could present a greater risk should the projected closing date not be met. Another example of an attribute is the value of the loan, with a loan for a greater amount potentially presenting a higher risk if the projected closing date is not met.

Next, at step 1020, the closeness of the projected closing date is determined. As the projected closing date approaches, the risk of deviations has a greater impact on possibly missing the projected closing date. For instance, when the closing date is three months away and one milestone lags a few days beyond the projected time, the ultimate projected closing date usually is not in jeopardy. However, when the closing date is a week away and the loan fails to meet a milestone, the risk to the loan not closing at the projected closing date is higher.

Next, at step 1030, the attributes and closeness of the projected closing date are used to calculate the score that prioritizes the loans. For each loan, the score can be a number that is normalized. One pseudo-algorithm for calculating the score is as follows:

$$Score = normalize ( [ loan type attribute ] + [ loan amount attribute ] + [ closeness to closing attribute ] + [ deviation from {milestone}_{1} ) + … [ deviation from {milestone}_{i} ] )$$

In this example, the score is given between 0-100, with a score of 50 being normal priority. Scores greater than 50 can represent those loans which are at jeopardy of not making their projected closing dates. Scores less than 50 indicate loans that are likely to close on time or even early.

Although a specific scoring method is provided in the examples, there are many other ways to prioritize. For instance, different metrics can be examined to develop a score. In another example, different scoring schemes can be used, such as a binary scoring scheme where each loan is assigned a “1” when at risk of missing the projected closing date and “0” when on target. Further, rather than scoring loans, the prioritization can simply flag loans that meet certain threshold criteria for further processing.

Next, at step 1040, the loans are prioritized based upon the scores. In one example, the loans are sorted according to score, with loans having the greatest scores being most at risk. The loans at the upper end of the sorted list therefore can be given attention, as needed, for remediation. In some examples, the loans with the highest scores (most at risk) can be flagged, color-coded, or otherwise highlighted.

At step 1050, various alerts and/or automated remedial actions can be performed. Alerts can be generated to various parties associated with the loan, such as the loan officer, etc. In other examples, the loans with the highest scores can automatically be assigned to a loan officer for further processing and possible remediation. In yet other examples, the projected closing date can automatically be adjusted based upon the score, and the relevant parties can be notified of the adjustment.

The prioritization can be updated as new information is provided. This can happen periodically, such as by performing the method 1000 at regular intervals, such as each hour, day, or week. In other examples, the method 1000 can be performed on each loan as additional information is made available, so a score for a loan can change based upon the additional information and the place in priority for the loan can be adjusted properly (e.g., higher or lower priority).

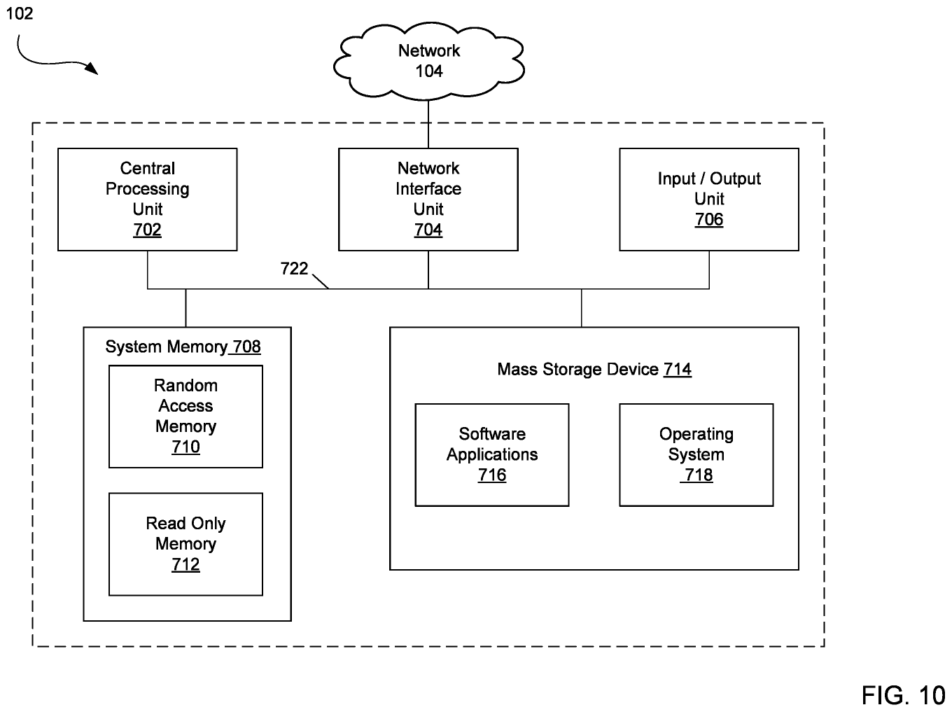

As illustrated in FIG. 10, the example user computing device 102 that executes the projected closing date tool includes at least one central processing unit (“CPU”) 702, also referred to as a processor, a system memory 708, and a system bus 722 that couples the system memory 708 to the CPU 702. The system memory 708 includes a random access memory (“RAM”) 710 and a read-only memory (“ROM”) 712. A basic input/output system that contains the basic routines that help to transfer information between elements within the user computing device 102, such as during startup, is stored in the ROM 712. The user computing device 102 further includes a mass storage device 714. The mass storage device 714 is able to store software instructions and data. Some or all of the components of the user computing device 102 can also be included in the user computing device 102 and any other computing devices described herein.

The mass storage device 714 is connected to the CPU 702 through a mass storage controller (not shown) connected to the system bus 722. The mass storage device 714 and its associated computer-readable data storage media provide non-volatile, non-transitory storage for the user computing device 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the user computing device 102.

According to various embodiments of the invention, the user computing device 102 may operate in a networked environment using logical connections to remote network devices through the network 104, such as a wireless network, the Internet, or another type of network. The user computing device 102 may connect to the network 720 through a network interface unit 704 connected to the system bus 722. It should be appreciated that the network interface unit 704 may also be utilized to connect to other types of networks and remote computing systems. The user computing device 102 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the user computing device 102 can store software instructions and data. The software instructions include an operating system 718 suitable for controlling the operation of the user computing device 102. The mass storage device 714 and/or the RAM 710 also store software instructions and software applications 716, that when executed by the CPU 702, cause the user computing device 102 to provide the functionality of the user computing device 102 discussed in this document. For example, the mass storage device 714 and/or the RAM 710 can store software instructions that, when executed by the CPU 702, cause user computing device 102 to display data on the display screen of the user computing device 102.

Although various embodiments are described herein, those of ordinary skill in the art will understand that many modifications may be made thereto within the scope of the present disclosure. Accordingly, it is not intended that the scope of the disclosure in any way be limited by the examples provided.

1. An electronic computing device, comprising:
a processor; and
a system memory, the system memory including instructions which, when executed by the processor, cause the electronic computing device to:
train, using historical data associated with at least one prior loan transaction, an artificial intelligence model configured to replicate an assessment of loan performance, wherein the artificial intelligence model is programmed to calculate operating service levels associated with a plurality of loan components of a loan transaction for purchase of a property;
continually update the artificial intelligence model using additional loan transaction for purchase of additional properties so that the artificial intelligence model adjusts to changes in process capabilities and market conditions;
receive a status and a date for each of the plurality of loan components associated with a loan transaction, the loan transaction being purchase or refinance of a loan for a property, and the plurality of loan components including an appraisal, a title, and insurance for the property;
calculate, by the artificial intelligence model, an operating service level associated with each of the plurality of loan components from the historical data associated with at least one prior loan transaction;
use the operating service level associated with each of the plurality of loan components to calculate a projected completion date for each of the plurality of loan components;
project a closing date based upon at least a longest of the calculated projected completion dates;
display a user interface including:
a number of days left for completion of the operating service level for each of the plurality of loan components;
the projected completion date for each of the plurality of loan components; and
the closing date; and
provide an alert when the closing date is after a relevant due date.

2. (canceled)

3. The electronic computing device of claim 1, wherein the status for each of the plurality of loan components includes one of:
required, which indicates that a respective loan component is necessary for the loan transaction;
requested, which indicates that an order for the respective loan component has been placed;
received, which indicates that documentation for the respective loan component has been received; and
satisfied, which indicates that the respective loan component has been completed.

4. (canceled)

5. The electronic computing device of claim 1, further comprising instructions which, when executed by the processor, cause the electronic computing device to:
compare the closing date to a rate expiration date; and
provide the alert when the closing date is after the rate expiration date.

6. The electronic computing device of claim 1, further comprising instructions which, when executed by the processor, cause the electronic computing device to:
compare the closing date to a borrower expected date; and
provide the alert when the closing date is after the borrower expected date.

7. The electronic computing device of claim 1, further comprising instructions which, when executed by the processor, cause the electronic computing device to highlight a longest projected completion date from the projected completion date for each of the plurality of loan components.

8. The electronic computing device of claim 1, further comprising instructions which, when executed by the processor, cause the electronic computing device to provide a summary of the status and the date for each of the plurality of loan components and the closing date associated with the loan transaction.

9. The electronic computing device of claim 1, further comprising instructions which, when executed by the processor, cause the electronic computing device to:
divide one or more of the plurality of loan components into a plurality of subcomponents; and
calculate operating service levels for each of the plurality of subcomponents.

10. The electronic computing device of claim 1, wherein the closing date is calculated by a software application executed by the electronic computing device.

11. The electronic computing device of claim 1, further comprising instructions which, when executed by the processor, cause the electronic computing device to calculate operating service levels using artificial intelligence.

12. The electronic computing device of claim 11, further comprising instructions which, when executed by the processor, cause the electronic computing device to develop a sequence of models for the artificial intelligence, with one model of the sequence of models being associated with each of the operating service levels.

13. A method for projecting a completion date for a loan transaction, the method comprising:
training, using historical data associated with at least one prior loan transaction, an artificial intelligence model configured to replicate an assessment of loan performance, wherein the artificial intelligence model is programmed to calculate operating service levels associated with a plurality of loan components of a loan transaction for purchase of a property;
continually updating the artificial intelligence model using additional loan transaction for purchase of additional properties so that the artificial intelligence model adjusts to changes in process capabilities and market conditions;
receiving a status and a date for each of the plurality of loan components associated with the loan transaction, the loan transaction being a purchase or a refinance of a loan for a property, and the plurality of loan components including an appraisal, a title, and insurance for the property;
calculating, by the artificial intelligence model, an operating service level associated with each of the plurality of loan components from the historical data associated with at least one prior loan transaction;
using the operating service level associated with each of the plurality of loan components to calculate a projected completion date for each of the plurality of loan components;
projecting a closing date based upon at least a longest of the calculated projected completion dates;
displaying a user interface including:
a number of days left for completion of the operating service level for each of the plurality of loan components;
the projected completion date for each of the plurality of loan components; and
the closing date; and
providing an alert when the closing date is after a relevant due date.

14. (canceled)

15. The method of claim 13, wherein the status for each of the plurality of loan components includes one of:
required, which indicates that a respective loan component is necessary for the loan transaction;
requested, which indicates that an order for the respective loan component has been placed;
received, which indicates that documentation for the respective loan component has been received; and
satisfied, which indicates that the respective loan component has been completed.

16. The method of claim 13, further comprising:
comparing the closing date to a rate expiration date; and
providing the alert when the closing date is after the rate expiration date.

17. The method of claim 13, further comprising:
dividing one or more of the plurality of loan components into a plurality of subcomponents; and
calculating operating service levels for each of the plurality of subcomponents.

18. The method of claim 13, wherein the closing date is calculated by a software application.

19. The method of claim 13, further comprising using artificial intelligence to calculate operating service levels.

20. The method of claim 19, further comprising developing a sequence of models for the artificial intelligence, with one model of the sequence of models being associated with each of the operating service levels.
